(19) United States
(12) Patent Application Publication
(10) Pub. No.: US 2010/0094899 A1
(43) Pub. Date: Apr. 15, 2010

(54) SYSTEM FOR ASSEMBLING AND PROVIDING PROBLEM SOLVING FRAMEWORKS

(75) Inventors: Paul Yiu, Mountain View, CA (US); Jian Chen, Sunnyvale, CA (US); Marc Davis, San Francisco, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/242,314

(22) Filed: Sep. 30, 2008

(51) Int. Cl. G06F 17/30; G06F 7/00; G06F 15/16

(52) U.S. Cl. 707/770; 709/218

(57) ABSTRACT

A system is described for assembling and providing problem solving frameworks. The system may include a processor, a memory and an interface. The memory may store a template for solving a problem. The template may include several tasks, each task associated with an attribute indicating whether the task should be performed by a machine. The interface may communicate with a user and components. The processor may receive a request to solve a problem and may identify the template for solving the problem. The processor may assign each task in the template to a machine component if the associated attribute indicates a machine should perform the task. The processor may provide the tasks to the assigned components and may receive responses from the assigned components. The processor may determine a solution to the problem based on the responses received from the components, and may provide the solution to the user.

### TECHNICAL FIELD

The present description relates generally to a system and method, generally referred to as a system, for assembling and providing problem solving frameworks, and more particularly, but not exclusively, to using socio-technical systems to provide solutions to user identified problems.

### BACKGROUND

Online services, such as YAHOO! ANSWERS, may allow a user to submit a problem or question and have people provide answers to the problem. Other online services, such as the YAHOO! CONVERSION CALCULATOR, may provide a user with computational resources to solve a problem. However, some problems may be too complex to be solved by machines or people alone.

### SUMMARY

A system is disclosed for assembling and providing problem solving frameworks. The system may include a processor, a memory and an interface. The memory may be operatively connected to the processor and the interface and may store a template for solving the problem. The template may include several tasks. Each task may be associated with an attribute indicating whether the task should be performed by a machine. The interface may communicate with a user and one or more components. The processor may receive a request to solve a problem from a user via the interface. The processor may identify the template for solving the problem and may assign each task in the template to a component. Each task may be assigned to a machine component if the attribute associated with the task indicates that the task should be performed by a machine. Otherwise each task may be assigned to a machine component. The processor may provide the tasks to the assigned components and may receive responses from the components via the interface. The processor may determine a solution to the problem based on the responses received from the components and may provide the solution to the user via the interface.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for assembling and providing problem solving frameworks.

FIG. 2 is block diagram of a simplified view of a network environment implementing the system of FIG. 1 or other systems for assembling and providing problem solving frameworks.

FIG. 3 is a block diagram of an implementation of a service provider server in the system of FIG. 1 or other systems for assembling and providing problem solving frameworks.

FIG. 4 is a block diagram illustrating the dataflow associated with solving a problem in the system of FIG. 1 or other systems for assembling and providing problem solving frameworks.

FIG. 5 is a flowchart illustrating operations of the system of FIG. 1, or other systems for assembling and providing problem solving frameworks.

FIG. 6 is a flowchart illustrating operations of building a solution template data store in the system of FIG. 1, or other systems for assembling and providing problem solving frameworks.

FIG. 7 is a flowchart illustrating operations of building a machine and human component registry in the system of FIG. 1, or other systems for assembling and providing problem solving frameworks.

FIG. 8 is an illustration a general computer system that may be used in a system for assembling and providing problem solving frameworks.

### DETAILED DESCRIPTION

A system and method, generally referred to as a system, relate to assembling and providing problem solving frameworks, and more particularly, but not exclusively, to using socio-technical systems to provide solutions to user identified problems. The principles described herein may be embodied in many different forms.

The system may allow a user to submit a problem and receive a solution to the problem. The user may submit the problem to the system using an internet service, an email service, a text messaging service, an instant messaging service, a voice response service, or generally any service capable of communicating the problem to the system. The problem may be most efficiently solved by using a combination of humans and machines. The system may maintain a registry of humans and machines, referred to as components, capable of contributing to solve the problem. The registry may contain the availability and capabilities of each component. The system may analyze the problem and transform the problem into a series of tasks. For each task, the system may determine whether the task would be better performed by a human or machine, and may assign the task to an available human or machine which has the capabilities to perform the task. The system may provide each of the tasks and any associated input to the assigned components. The system may receive responses from the components when the tasks are completed. The response received from one component may be used as an input for a task of another component. The system may process the responses received from the components determine an answer to the submitted problem. The system may provide the determined answer to the user. The system may provide the answer to the user through an internet service, an email service, a text messaging service, a voice system, an instant messaging service, or generally any service capable of communicating the answer to the user.

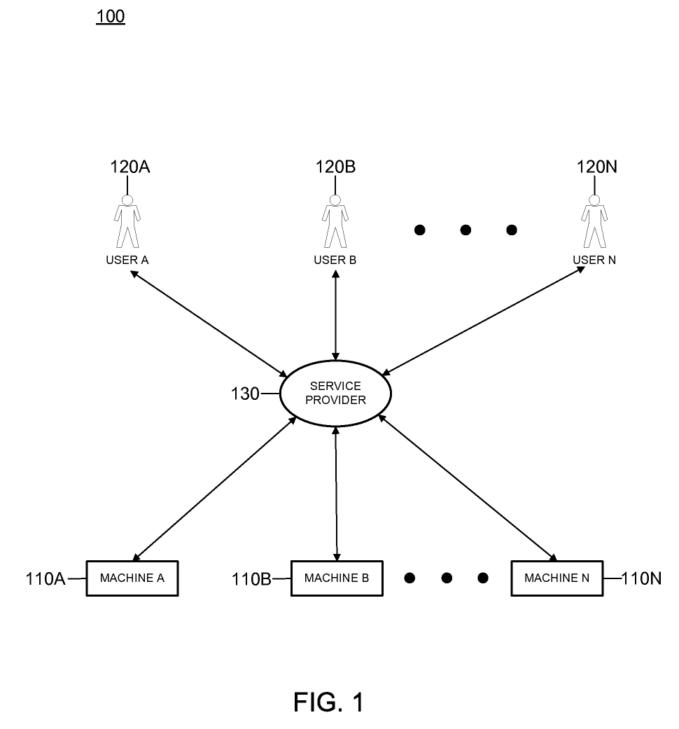

FIG. 1 provides a general overview of a system 100 for assembling and providing problem solving frameworks. Not all of the depicted components may be required, however, and some implementations may include additional components. Variations in the arrangement and type of the components may be made without departing from the spirit or scope of the claims as set forth herein. Additional, different or fewer components may be provided.

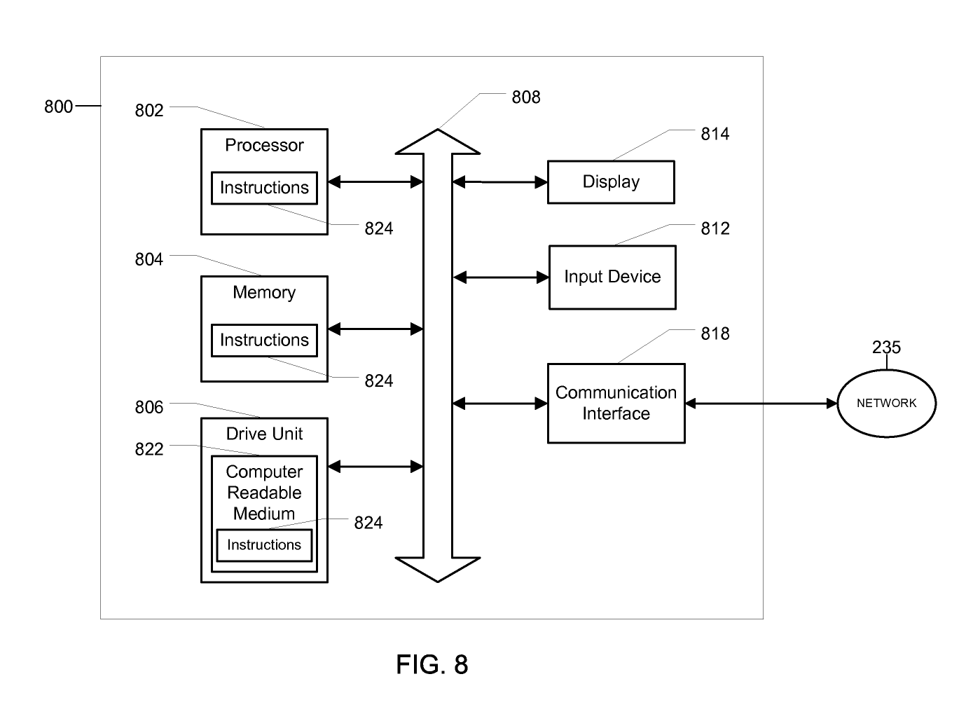

The system 100 includes users 120A-N, machines 110A-N, and a service provider 130. The users 120A-N may be one or more persons interacting with the service provider. The machines 110A-N may be one or more computing devices interacting with the service provider 130, such as the computing device described in FIG. 8 below. The users 120A-N and machines 110A-N may be capable of completing tasks provided by the service provider 130, and may be referred to as components. The users 120A-N and machines 110A-N may also submit problems to the service provider 130 and receive solutions to the problems from the service provider 130.

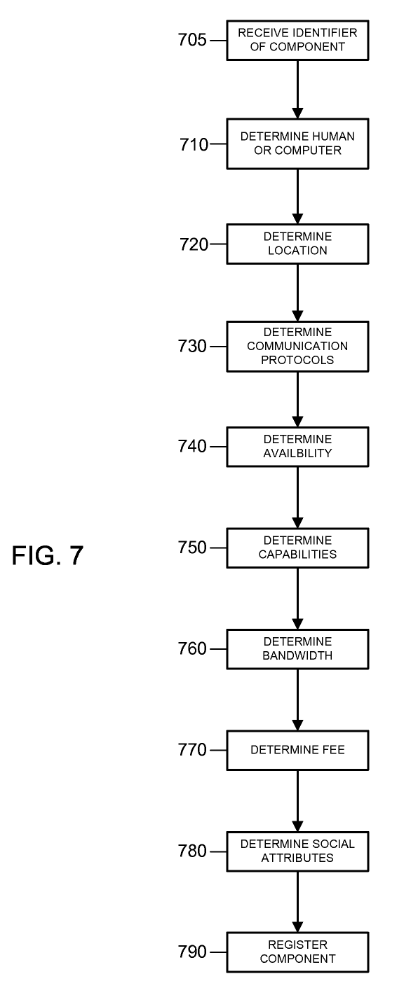

The users 120A-N may communicate with the service provider 130 through web pages, emails, mobile phone applications, text messages, phone calls, faxes, standard mail, or generally any mode of communicating information. The machines 110A-N may communicate with the service provider 130 through a data connection over a network. The machines 110A-N may communicate with the service provider 130 via a synchronous or asynchronous transaction. The service provider 130 may maintain a component registry of each of the users 120A-N and machines 110A-N which are capable of completing tasks assigned by the service provider 130. The service provider 130 may store attributes describing the capabilities of each the users 120A-N and machines 110A-N. The attributes may be used by the service provider 130 to determine whether the users 120A-N or machines 110A-N are capable of completing a given task. The attributes may be any data describing the capabilities of the users 120A-N and/or machines 110A-N, such as availability, input/output capabilities, communication protocols, language, distance, location, bandwidth, cost, or social attributes. Generally the machines 110A-N may provide computational capabilities, such as performing mathematical calculations, while the users 120A-N may provide cognitive capabilities, such as identifying and transcribing the text on a sign in a photograph. The steps associated with building the component registry are discussed in more detail in FIG. 7 below.

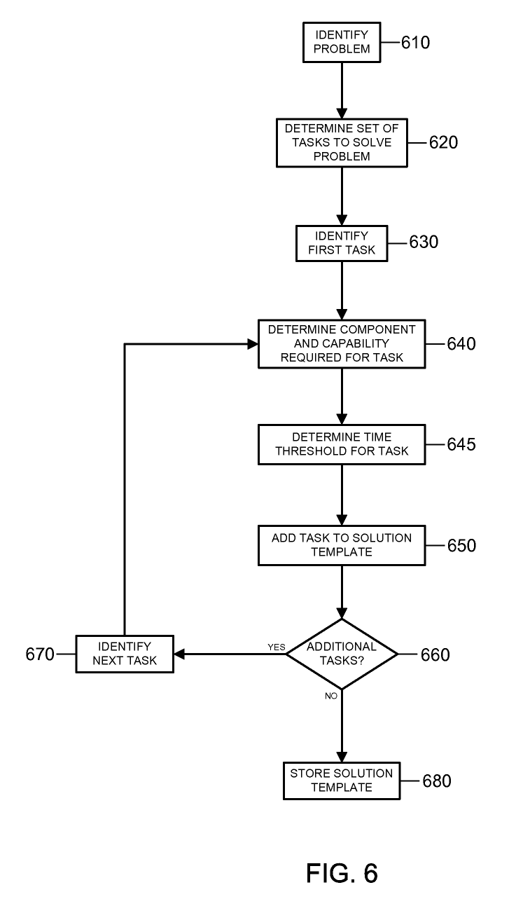

The service provider 130 may maintain a solution template data store. The solution template data store may store templates for solving the problems supported by the system 100. A solution template may describe several individual tasks which may be completed by the users 120A-N and/or machines 110A-N to solve the problem. The tasks may require an input and may provide an output, or response. The tasks may be associated with data describing the capabilities required to complete the task. The service provider 130 may use the data describing the capabilities required to complete the task to determine which of the users 120A-N and/or machines 110A-N is best suited to complete the task. The steps associated with building the solution template data store are discussed in more detail in FIG. 6 below.

In operation, one of the users 120A-N, such as the user A 120A may submit a problem to the service provider 130. The problem may be an issue encountered by the user A 120A in the real world. For example, the user A 120A may see a sign in a foreign country and may need the sign translated. Alternatively or in addition the user A 120A may need to know how much tip to leave at a restaurant in a foreign country. The user A 120A may provide an input with the problem, such as a digital photo of the sign, or restaurant receipt. If the user A 120A is capable of reading the restaurant receipt the user A 120A may provide a text input corresponding to the total on the receipt.

The service provider 130 may provide a pre-populated selection of problems to the user A 120A which the user A 120A may select from. The pre-populated problems may correspond to the problems solvable by the solution templates stored in the template data store. Alternatively or in addition the user A 120A may submit a free form question or problem. In this case the service provider 130 may provide a task to one of the users 120A-N or machines 110A-N of determining which solution template corresponds to the submitted problem. Alternatively or in addition if no solution template exists for the submitted problem one of the users 120A-N or machines 110A-N may be assigned the task of generating a solution template for the problem.

Once the service provider 130 identifies a solution template corresponding to the submitted problem, the service provider 130 may identify the attributes indicating the capabilities required to complete each task in the solution template. The service provider 130 may identify the currently available machines 110A-N or users 120A-N components capable of completing each task. The machines 110A-N or users 120A-N components may be machines or users who have opted in to answer a certain type of question or solve a certain type of problem. The service provider 130 may assign each task to an available component capable of completing the task, and may store the task and the assigned component in a task state data store. The task data store may store a state for each assigned task, such as whether the task is unassigned, pending, in progress, or completed. The task state data store may also indicate whether each task requires an input received from the completion of another task. The task state data store may be used to determine the order the tasks should be provided to the components and whether one or more tasks may be performed in parallel. The tasks may be completed in serial and/or in parallel.

The service provider 130 may provide each task, and any required input, to the assigned component. The service provider 130 may receive a response from the component when the task is completed. For example, in the case of determining how much of a tip to at a restaurant in a foreign country, the service provider 130 may receive a photo of the receipt from the user A 120A and may provide a photo of the receipt to the user B 120B. The user B 120B may be capable of reading the language used in the foreign country and may provide a response to the service provider 130 indicating what the total amount of the receipt is. However, the user B 120B may be unaware of the local customs in the country, or city, where the restaurant is located. Thus, in parallel to providing the receipt to the user B 120B, the service provider 130 may provide a task to the user N 120N of determining the customary tip percentage in the country, region, or city, where the restaurant is located. The user N 120N may have local knowledge of the area where the restaurant is located, or may have access to a repository, such as the Internet, where the task may be researched. Once the service provider 130 receives the total amount of the bill from the user B 120B, and the customary tip percentage, the service provider 130 may provide the total amount and the tip percentage to the machine A 110A. The machine A 110A may be capable of computing the total bill amount and providing the total to the service provider 130. The service provider 130 may then communicate the tip and total amount to the user A 120A. Alternatively or in addition if the user A 120A wanted to know what the total amount of the bill was in another currency, the service provider 130 may assign the task of converting the amount to a machine B 110B with knowledge of the current exchange rates.

The service provider 130 may store the time when a task is provided to a component in the task state data store. The service provider 130 may monitor the progress of the components to determine whether the components are completing the assigned tasks in a timely fashion. The service provider 130 may associate each task with a timeout threshold. The timeout threshold may indicate the maximum time allocated to each task. If a component surpasses the timeout threshold for the task without providing a response, the service provider 130 may provide the task to an alternate component. The service provider 130 may use the first response received from either component the task was assigned to. Alternatively or in addition the service provider 130 may assign each task to several components and may use the first response received from any of the components.

Alternatively or in addition the service provider 130 may provide the solution template to the component performing the first task. The solution template may contain the ordered list of tasks to be completed along with an identifier for each component assigned a task, a protocol for communicating with each component, and an address for communicating with the component via the protocol. The service provider 130 may ensure that each the component for each task is capable of communicating with the component assigned to the previous task and the component assigned to the next task. The first component may complete the assigned task and may then process the solution template to determine the component assigned the next task. The component may then communicate the response for the assigned task and the solution template to the next component via the specified communication protocol. Alternatively or in addition the service provider 130 may communicate the tasks to the components simultaneously along with the communication protocol and address to communicate their respective responses to. The components may perform their task and provide their response to the identified address. If a component requires a response from a second component to complete the assigned task the component may wait to complete the task until the response is received.

The service provider 130 may charge a fee to the user A 120A for each problem the service provider 130 solves for the user A 120A. The fee may be subscription based or may be based on the complexity of each problem, such as the number of tasks and complexity of tasks completed to solve the problem. The service provider 130 may provide a payment to each of the components that assisted in solving the problem. The payment may be based on the amount of time spent on a task by the component, such as an hourly rate, or may be a fixed payment based on the complexity of the task. If the service provider 130 provides a task to multiple components, only the first responding component may receive payment for the task.

The service provider 130 may include one or more advertisements with the solution provided to the user A 120A. The advertisements may be relevant to the solution, the problem, the tasks used to solve the problem, information describing the user A 120A or the behavior of the user A 120A, information obtained from the input provided by the user A 120A, such as the name of a restaurant, or generally the advertisements may be relevant to any data associated with solving the problem submitted by the user A 120A. The advertisements may be provided to the user A 120A in same format that the solution is provided to the user A 120A. For example, if the user A 120A communicates with the service provider 130 via text messages, or multimedia messages, the advertisements may be provided to the user A 120A via text messages or multimedia messages. Alternatively or in addition if the user A 120A communicates with the service provider 130 via a voice system, the advertisements may be provided in an audio format to the user A 120A. The user A 120A may not be required to pay a fee for the service if the user A 120A agrees to receive advertisements with the solutions.

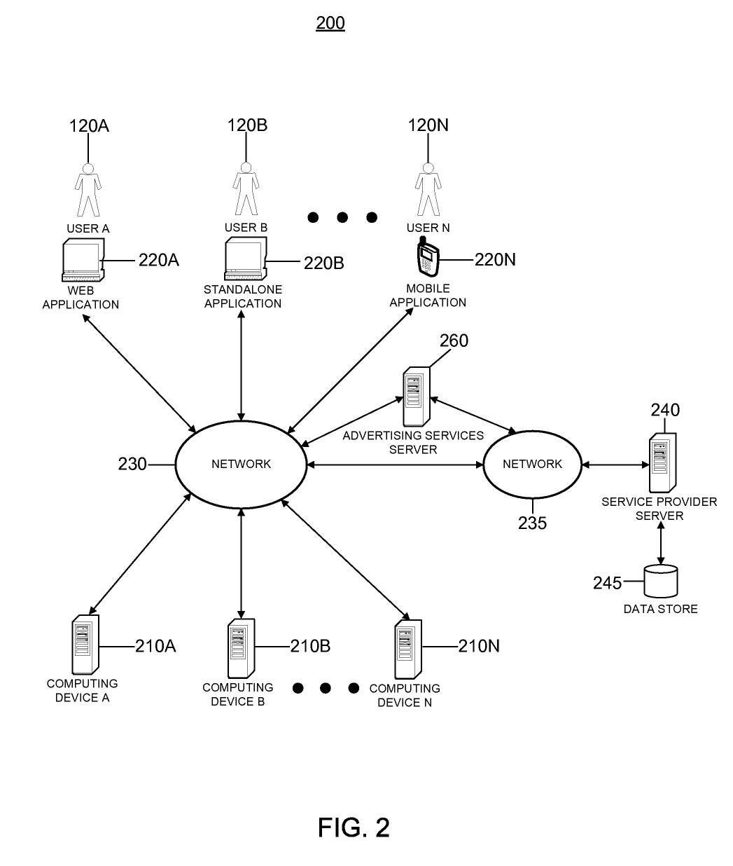

FIG. 2 provides a simplified view of a network environment implementing a system 200 for providing contextually relevant data. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 200 may include one or more web applications, standalone applications and mobile applications 220A-N, which may be collectively or individually referred to as client applications of the users 120A-N. The mobile applications may include mobile messaging applications, mobile browsers, or a telephony application. For example, a mobile application may be an application designed for the APPLE IPHONE, such as a mobile application for finding a restaurant. The system 200 may also include one or more computing devices 210A-N, a network 230, a network 235, the service provider server 240, a data store 245, and an advertising services server 260. Some or all of the service provider server 240 and the advertisement services server 260 may be in communication with each other by way of network 235.

The computing devices 210A-N, the service provider server 240 and the advertisement services server 260 may each represent multiple linked computing devices and may each be the system or components described in FIG. 8 below. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (“TCP/IP”) protocol suite.

The networks 230, 235 may include wide area networks (“WAN”), such as the internet, mobile networks, local area networks (“LAN”), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The users 120A-N may use a web application 220A, standalone application 220B, or a mobile application 220N, or any combination thereof, to communicate to the service provider server 240, such as via the networks 230, 235. The service provider server 240 may communicate to the users 120A-N via the networks 230, 235, through the web applications, standalone applications or mobile applications 210A-N. The mobile applications 210A-N may include a standard telephone device.

The web applications, standalone applications, and mobile applications 220AA-NN may be connected to the network 230 in any configuration that supports data or voice transfer. This may include a data or voice connection to the network 230 that may be wired or wireless. Any of the web applications, standalone applications and mobile applications 220A-N, may individually be referred to as a client application. The web application 220A may run on any platform that supports web content, such as a web browser or a computer, a mobile phone, personal digital assistant (“PDA”), pager, network-enabled television, digital video recorder, such as TIVO®, automobile and/or any appliance capable of data communications.

The standalone applications 220B may run on a machine that may have a processor, memory, a display, a user interface and a communication interface. The processor may be operatively connected to the memory, display and the interfaces and may perform tasks at the request of the standalone application 220B or the underlying operating system. The memory may be capable of storing data. The display may be operatively connected to the memory and the processor and may be capable of displaying information to the user B 220B. The user interface may be operatively connected to the memory, the processor, and the display and may be capable of interacting with a user B 120B. The communication interface may be operatively connected to the memory, and the processor, and may be capable of communicating through the networks 230, 235 with the service provider server 240 and advertising services server 260. The standalone application 220B may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others.

The mobile application 220N may run on any mobile device which may have a data or voice connection. The mobile applications 220N may be a mobile messaging application, a mobile browser, a microbrowser, or a telephony application. The mobile application 220N may be hosted on one of a broad range of electronic devices which may include mobile phones, PDAs, and laptops and notebook computers. Some of the electronic devices may have a reduced feature set, such as a smaller keyboard and/or screen, and may be incapable of supporting a traditional web search or may be incapable of accessing the Internet. A data connection of the electronic devices may be a cellular connection, such as a GSM/GPRS/WCDMA connection, a wireless data connection, an internet connection, an infra-red connection, a Bluetooth connection, or any other connection capable of transmitting data.

The service provider server 240 may include one or more of the following: an application server, a data source, such as a database server, a middleware server, and the advertising services server 260. The application server may be APACHE TOMCAT, MICROSOFT IIS, ADOBE COLDFUSION, YAPACHE or any other application server that supports communication protocols. The middleware server may be any middleware that connects software components or applications. The application server on the service provider server 240 may serve pages, such as web pages to the users 120AA-NN. The service provider server 240 may exist on one machine or may be running in a distributed configuration on one or more machines. The advertising services server 260 may provide a platform for the inclusion of advertisements in solutions provided to the users 120A-N, such as through web pages, mobile pages or mobile messages.

The data store 245 may store one or more of the component registry, the task state data store and the solution template data store. There may be several configurations of database servers included in the data store 245. The database servers may include MICROSOFT SQL SERVER, ORACLE, IBM DB2 or any other database software, relational or otherwise. The data store 245 may communicate directly with the service provider server 240 or may communicate to the service provider server 240 through the networks 230, 235.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (“LAN”), a wide area network (“WAN”), a direct connection such as through a Universal Serial Bus (“USB”) port, and the like, and may include the set of interconnected networks that make up the Internet. The networks 230, 235 may include any communication method by which information may travel between computing devices.

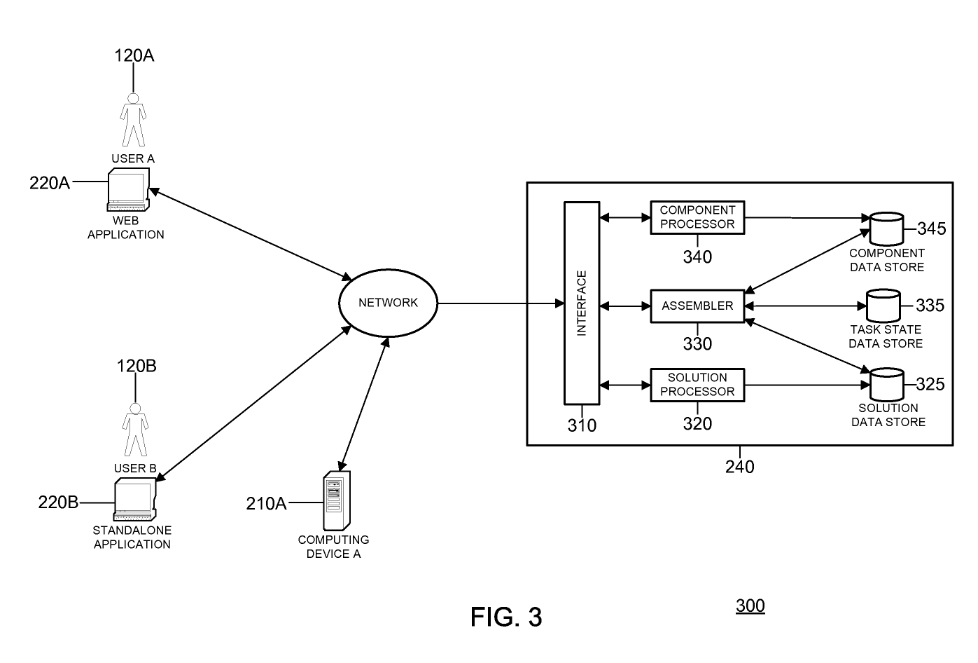

FIG. 3 illustrates a block diagram of a service provider server 240 implementation 300 in the system of FIG. 1 or other systems for assembling and providing problem solving frameworks. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The implementation 300 may include a user A 120A, a web application A 220A, a user N 120N, a mobile application 220N, a computing device 210A, and a service provider server 240. The service provider server 240 may include an interface 310, a component processor 340, a component data store 345, a solution processor 320, a solution data store 325, an assembler 330 and a task state data store 335. The interface 310 may be used for communicating with the web application 220A, the mobile application 220N and the computing device 210A. The component data store 345 may store the component registry. The solution data store 325 may store the solution templates. The task state data store 335 may store the state of the tasks assigned for a given solution template.

In operation, the component processor 340 may process an identifier of a component, such as the user N 120N or the computing device A 110A, determine the associated capability attributes of the component and store the identifier of and the attributes in the component data store 345. The solution processor 320 may process the solution templates and the associated tasks and may store the templates and tasks in the solution data store 325.

The user A 120A may provide a problem to the service provider server 240 via the interface 310. The assembler 330 may receive the problem, and retrieve the solution template for the problem from the solution data store 325. The assembler 330 may identify each task associated with the solution template and the capabilities required to complete the task. The assembler 330 may identify available components in the component data store 345 capable of performing each task. The assembler 330 may assign each task to an available component in the component data store 345 and may store each task and an identifier of the component assigned to each task in the task state data store 335.

The assembler 330 may determine the order the tasks should be provided to the components based on the solution template. The assembler 330 may provide each task to the assigned component, in the determined order, along with to any input required to complete the task, as identified in the solution template. The assembler 330 may update the availability of an assigned component in the component data store 345 to reflect that the component is performing a task. The assembler 330 may maintain the state of the task in the task state data store 335. The assembler 330 may receive responses from the components and may update the task state data store 335 based on the responses received. The assembler 330 may monitor the task state data store 335 to ensure each of the tasks is completed within the timeout threshold indicated in the solution template. If a task is not completed within the timeout threshold the assembler 330 may provide the task to another available component capable of completing the task.

The assembler 330 may determine when the last task has been completed and may provide the solution to the user A 120A via the web application 220A. The solution may be the response provided by the component assigned to the last task. Alternatively or in addition the assembler 330 may process the responses provided by the components to determine the solution to the problem.

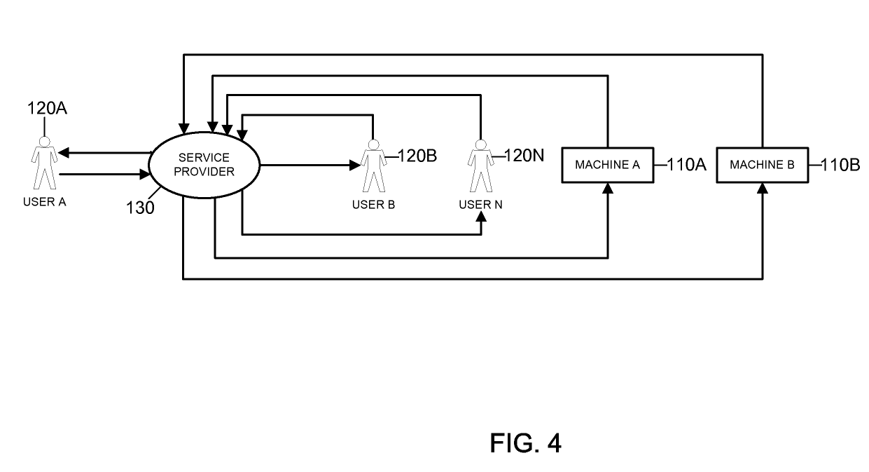

FIG. 4 illustrates a block diagram of the dataflow 400 associated with solving a problem in the system of FIG. 1 or other systems for assembling and providing problem solving frameworks. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The dataflow 400 includes the user A 120A, the service provider 130, the user B 120B, the user N 120N, the machine A 110A, and the machine B 110B. In operation the user A 120A may communicate a problem to the service provider along with any input associated with the problem. For example, the user A 120A may submit a problem of determining the amount of tip to leave at a restaurant in a foreign country, and determining the total cost of the bill in United States dollars. The user A 120A may include a digital photograph of the receipt as input associated with the problem.

The service provider 130 may retrieve a solution template for the problem. The solution template may indicate that the tasks required to solve the problem may include determining the total amount on the receipt, determining the customary tipping percentage at the location of the restaurant, calculating the tip, and determining the equivalent of the total bill in United States dollars. The service provider 130 may determine the location of the user A 120A based on a positioning system associated with the device used by the user A 120A, such as a global positioning system. Alternatively or in addition the service provider 130 may assign a component an initial task to be determining the location of the user A 120A based on the digital photograph of the receipt.

The service provider 130 may determine the language used on the receipt based on the location of the user A 120A. The service provider 130 may determine that the user B 120B is associated with a capability attribute of being able to read the language used on the receipt, and a capability attribute of being able to view the receipt. The service provider 130 may provide the receipt and a description of the task of determining the total amount on the receipt to the user B 120B. The user B 120B may respond with the total amount on the receipt. The user B 120B may not be associated with knowledge of local information, such as customary tipping percentages.

The service provider 130 may determine that the userN 120N has knowledge of the local customs at the location of the user A 120A. The user N 120N may be located in the same location as the user A 120A, may have an identified expertise in local customs, or may have access to a knowledge repository, such as the Internet, where local customs can be researched. The service provider 130 may provide the task of determining the customary tip percentage in the location of the user A 120A to the user N 120N. Since determining the customary tip percentage is not dependent on the total bill, the service provider 130 may provide the task to the user N 120N in parallel to providing the first task to the user B 120B. Alternatively or in addition the service provider 130 may provide the tasks to the users 120B-N in serial.

The user N 120N may determine the customary tip percentage and may provide a response containing the customary tip percentage to the service provider 130. The service provider 130 may determine that the machine A 110A is capable of performing the computation of calculating the tip on a receipt based on the total amount and the tip percentage. Since the calculation may not require significant processing power, the machine A 110A may be a machine with limited computational capabilities. If the task required greater processing power the service provider 130 may identify a machine in the component data store 345 with greater processing capabilities. The service provider 130 may provide the task of determining the tip amount to the machine A 110A along with the total amount and the customary tip percentage. The machine A 110A may compute the tip and may provide the tip and the total amount of the bill to the service provider 130. The machine A 110A may not have the capability of determining exchange rates of foreign currencies to United States dollars.

The service provider 130 may determine that the machine B 110B is associated with the capability of currency exchange rates and has sufficient computational capabilities to calculate the conversion. The service provider 130 may provide a description of the task, the total amount, and the location of the user A 120A to the machine B 110B. The machine B 110B may determine the exchange rate for the currency based on the location of the user A 120A. The machine B 110B may convert the total amount to United States dollars and may provide the amount in United States dollars to the service provider 130. The service provider 130 may then provide the user A 120A with the tip amount, total amount in the local currency, and the total amount in United States dollars.

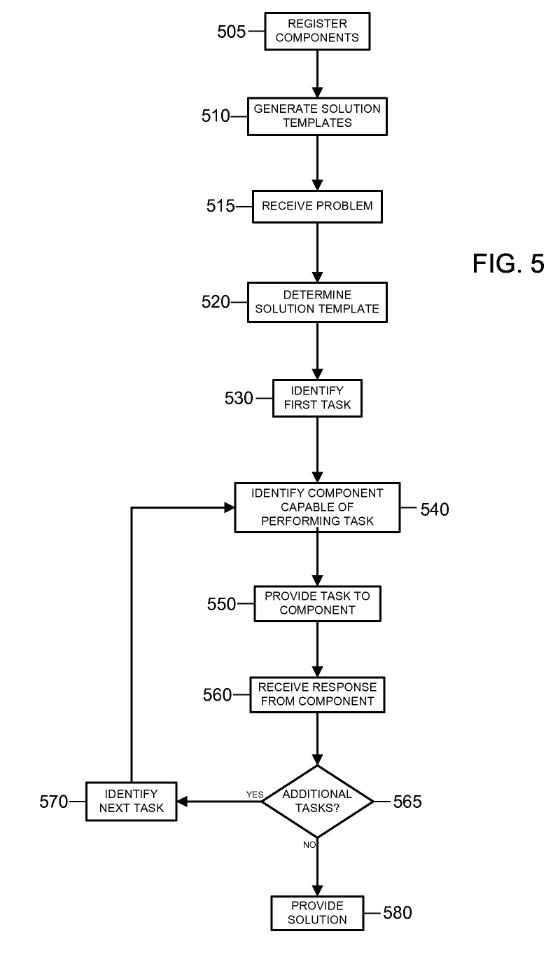

FIG. 5 is a flowchart illustrating operations of the system of FIG. 1, or other systems for assembling and providing problem solving frameworks. At block 505 the service provider 130 registers the available user 120A-N components and machine 110A-N components in the component data store 345. The service provider 130 may store an identifier of each component and one or more attributes relating to the availability and capabilities of the component. The steps of building the component data store 345 may be discussed in more detail in FIG. 7 below.

At block 510 the service provider 130 may generate one or more solution templates and store the solution templates in the solution data store 325. The solution templates may be determined by an administrative or expert user and may split out into one or more tasks. Each task may be associated with the capability required to complete the task, whether one of the machines 110A-N or one of the users 120A-N is preferred for the task, and the time allocated for completing the task. The steps of generating the solution templates may be discussed in more detail in FIG. 6 below.

At block 515 the service provider 130 may receive a problem from the user A 120A along with any associated input data. The input data may include a digital photograph, a spoken word, a video, a text entry, or generally any data associated with the problem. At block 520 the service provider 130 may determine the solution template capable of solving the received problem. In one example the user A 120A may identify a problem from a pre-populated set of problems. Each of the problems may be associated with a solution template stored in the solution data store 325. Alternatively or in addition the service provider 130 may assign an initial task of determining the solution template capable of solving the received problem to the user B 120B, or generating a solution template capable of solving the received problem. In this case the user B 120B may be an expert or administrative user.

At block 530 the service provider 130 may determine the first task to be completed in the solution template. At block 540 the service provider 130 may identify an available component in the component data store 345 capable of completing the task. The service provider 130 may compare the capabilities required by the task with the capability attributes of the components in the component data store 345. The service provider 130 may further determine whether the task indicates that a user 120B-N or a machine 110A-N is preferred to perform the task.

At block 550 the service provider 130 may provide the task to the identified component via the communication protocol utilized by the component. For example if the service provider 130 identifies the user B 120B and an attribute associated with the user B 120B indicates that the user B 120B only has access to a telephone, the service provider 130 may call the user B 120B and provide the task and associated input via spoken word. At block 560 the service provider 130 may receive a response for the task from the component. The task may be received from the component via the same, or different, protocol in which the task was provided to the component. At block 565 the service provider 130 may determine whether additional tasks exist in the solution template. If, at block 565, the service provider 130 determines that additional tasks exist in the solution template, the system 100 moves to block 570. At block 570 the service provider 130 identifies the next task in the solution template. The system 100 then returns to block 540, and repeats the steps of identifying a component, providing the task to the component and receiving the response from the component. The system 100 may repeat these steps for each remaining task in the task template.

If, at block 565, the service provider 130 determines that no additional tasks exist in the solution template, the system 100 moves to block 580. At block 580 the system 100 provides the solution to the user A 120A. The solution may be the response received from the component assigned to the last task in the solution template. Alternatively or in addition the service provider 130 may process the responses received from one or more of the components to determine the solution.

FIG. 6 is a flowchart illustrating operations of building a solution template data store in the system of FIG. 1, or other systems for assembling and providing problem solving frameworks. At block 610 the system 100 identifies a problem. The problem may relate to a real world problem which may be encountered by the users 120A-N, or a network problem which may be encountered by one of the machines 110A-N. The problem may be identified by an expert or administrative user or may automatically be identified by the service provider 130. Alternatively or in addition the system 100 may identify a new problem when a user A 120A provides a problem which can not be solved by one of the solution templates stored in the solution data store 325.

At block 620 the system 100 may separate the problem into a set of individual tasks. The tasks, when completed, may yield a solution to the problem. An administrative or expert user may determine the set of tasks, or one of the users 120A-N or machines 110A-N may be assigned the task of determining the set of tasks. Each task may be independent of the other tasks, or one or more tasks may require an input provided by another task. Whether or not the tasks are independent of each other may determine if the tasks must be completed sequentially or can be completed in parallel.

At block 630 the system 100 may identify the first task in the set of tasks. At block 640 the system 100 may determine the component and capability required for completing the task. The component and capability for the task may be identified by the expert user. The expert user may specify that the task be assigned to either a user or a machine based on the computational and cognitive requirements of the task. For example, if the task requires viewing a photograph and transcribing a number located in a part of the photograph, the task may be more suitable for one of the users 120A-N rather than one of the machines 110A-N. The machines 110A-N may require significant processing power to identify the area of the photo where the number is located and to recognize the number, whereas any literate user A 120A may be capable of recognizing the number in the photograph.

The capabilities required for a task may include knowledge of more than one language, specific bandwidth capabilities, specific input/output capabilities, such as the ability to view a photograph, or generally any capability required for completing a task. The required capabilities may be dynamic in the sense that the details of the capability may depend on the actual problem received. For example, in the case of a task which requires the capability of knowing multiple languages, the actual languages will not be known until the problem is received. Thus, the generally capability may be knowledge of multiple languages, and the capability may be supplemented with information describing the specific languages once the problem is received.

At block 645 the system 100 may determine the amount of time necessary for completing the task. The amount of time may be provided by the expert user. The amount of time may be used as a threshold such that the system 100 may assume the component has failed to complete the task if the task is not completed within the specified amount of time. The amount of time may be based on the complexity of the task. For example, transcribing a word in a digital photograph may be allocated five minutes. If no amount of time is provided the system 100 may set a default timeout for the task, such as one hour.

At block 650 the system 100 may add the task and the associated capability attributes to the solution template. At block 660 the system 100 may determine whether additional tasks exist. If, at block 660, the system 100 determines that additional tasks exist, the system 100 moves to block 670. At block 670 the system 100 identifies the next task and repeats the process of adding the task to the solution template. The system 100 may repeat the process for each of the remaining identified tasks.

If, at block 660, no additional tasks exist, the system 100 may move to block 680. At block 680 the system 100 may store the solution template, along with the associated tasks and task attributes, in the solution data store 325.

FIG. 7 is a flowchart illustrating operations of building a machine and human component registry in the system of FIG. 1, or other systems for assembling and providing problem solving frameworks. At block 705 the system 130 may receive an identifier of a component, such as one of the users 120A-N or one of the machines 110A-N. For example, the user A 120A may interact with a web page provided by the service provider 130 in order to register with the service provider 130 as a component. At block 710 the service provider 130 determines whether the component is a user or a machine. The service provider 130 may request the component indicates whether it is a human or a machine. Alternatively or in addition the service provider 130 may provide a task to the component to determine whether the component is a human or machine. The task may be transcribing a word appearing in an image, a task which only a user may be capable of completing within a fixed amount of time.

At block 720 the service provider 130 determines the location of the component. The location of the component may be determined based on the internet protocol (“IP”) address of the component, a positioning system associated with the component, or the component may provide their location. At block 730 the service provider 130 may determine the protocols which the component can communicate through. The default communication protocol may be the communication protocol used by the component to register with the service provider 130. The component may also provide additional communication protocols which may be used. The component may communicate with the service provider 130 through a network, such as a TCP/IP connection, a messaging service, an email service, a phone line, or generally any mode of communication. The component may provide an address for each communication protocol identified, such as a phone number, an email address, a mobile messaging address, an IP address, or generally any address for communicating with the component over the specified protocol.

At block 740 the service provider 130 may determine the periods of time when the component is available to perform tasks. The availability may be based on when the component is available to perform tasks within the allocated time period. The component may provide their availability or the service provider 130 may automatically populate default values for the availability. The default availability may be weekdays from 1700 hours to 2200 hours and weekends from 0800 hours to 2000 hours. The availability may also include an attribute indicating the number of tasks the component can process. The amount of tasks may be the same across the entire availability period or may fluctuate based on the time of day or the day of the week.

At block 750 the service provider 130 may determine the capabilities of the component. The capabilities may refer to computational capabilities, such as the number of processors of a machine A 110A, language capabilities, such as the languages a user A 120A can read, write, and speak, device capabilities, such as whether the user A 120A has access to a display, or the operating system or software installed on a machine A 110A, or generally any capabilities the users 120A-N or the machines 110A-N may possess. The service provider 130 may provide a list of indexed and selectable capabilities to the users 120A-N and to the administrators of the machines 110A-N, or the capabilities may be provided by the users 120A-N and/or administrators in free-form. In the case of the capabilities being provided in free form, an expert user may index the provided capabilities.

At block 760 the service provider 130 may determine the bandwidth of the component. The bandwidth may be automatically determined based on the connection with the component or the component may specify a bandwidth. At block 770 the service provider 130 may determine any fee associated with the component. The fee may be amount the component must be paid in order to complete a task. The fee may be fixed by the service provider 130 across all components, such as a hourly rate, the fee may be based on the capabilities of the component, for example a user A 120A with a degree in quantum physics may receive a higher fee than a user without a college degree, or the component may specify their own fee.

At block 780 the component may specify any social attributes. The social attributes may refer to the social networks the component belongs to, or generally any attribute describing the social networking of the component. The social attribute may only apply to the users 120A-N. The social attribute may be used to provide tasks of a problem received from the user A 120A to the users 120B-N in the same social network or group as the user A 120A. The user A 120A may indicate a preference that users 120B-N in their social network are assigned the tasks associated with their problem.

At block 790 the service provider 130 may register the component. Registering the component may include storing an identifier of the component and the attributes associated with the component in the component data store 345. The attributes of the component may be stored in such a way that the capabilities of the component can be quickly compared against the capabilities required for a given task. For example, the capabilities of the component, and whether the component is a user or a machine maybe indexed in the component data store 345.

FIG. 8 illustrates a general computer system 800, which may represent a service provider 130, or any of the other computing devices referenced herein. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The computer system 800 may include a set of instructions 824 that may be executed to cause the computer system 800 to perform any one or more of the methods or computer based functions disclosed herein. The computer system 800 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 800 may also be implemented as or incorporated into various devices, such as a personal computer (“PC”), a tablet PC, a set-top box (“STB”), a personal digital assistant (“PDA”), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 824 (sequential or otherwise) that specify actions to be taken by that machine. In a particular embodiment, the computer system 800 may be implemented using electronic devices that provide voice, video or data communication. Further, while a single computer system 800 may be illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, such as, a central processing unit (“CPU”), a graphics processing unit (“GPU”), or both. The processor 802 may be a component in a variety of systems. For example, the processor 802 may be part of a standard personal computer or a workstation. The processor 802 may be one or more general processors, digital signal processors, application specific integrated circuits, field programmable gate arrays, servers, networks, digital circuits, analog circuits, combinations thereof, or other now known or later developed devices for analyzing and processing data. The processor 802 may implement a software program, such as code generated manually (i.e., programmed).

The computer system 800 may include a memory 804 that can communicate via a bus 808. The memory 804 may be a main memory, a static memory, or a dynamic memory. The memory 804 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 804 may include a cache or random access memory for the processor 802. Alternatively or in addition, the memory 804 may be separate from the processor 802, such as a cache memory of a processor, the system memory, or other memory. The memory 804 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 804 may be operable to store instructions 824 executable by the processor 802. The functions, acts or tasks illustrated in the figures or described herein may be performed by the programmed processor 802 executing the instructions 824 stored in the memory 804. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 800 may further include a display 814, such as a liquid crystal display (“LCD”), an organic light emitting diode (“OLED”), a flat panel display, a solid state display, a cathode ray tube (“CRT”), a projector, a printer or other now known or later developed display device for outputting determined information. The display 814 may act as an interface for the user to see the functioning of the processor 802, or specifically as an interface with the software stored in the memory 804 or in the drive unit 806.

Additionally, the computer system 800 may include an input device 812 configured to allow a user to interact with any of the components of system 800. The input device 812 may be a number pad, a keyboard, or a cursor control device, such as a mouse, or a joystick, touch screen display, remote control or any other device operative to interact with the system 800.

The computer system 800 may also include a disk or optical drive unit 806. The disk drive unit 806 may include a computer-readable medium 822 in which one or more sets of instructions 824, e.g. software, can be embedded. Further, the instructions 824 may perform one or more of the methods or logic as described herein. The instructions 824 may reside completely, or at least partially, within the memory 804 and/or within the processor 802 during execution by the computer system 800. The memory 804 and the processor 802 also may include computer-readable media as discussed above.

The present disclosure contemplates a computer-readable medium 822 that includes instructions 824 or receives and executes instructions 824 responsive to a propagated signal; so that a device connected to a network 230 may communicate voice, video, audio, images or any other data over the network 230. The instructions 824 may be implemented with hardware, software and/or firmware, or any combination thereof. Further, the instructions 824 may be transmitted or received over the network 230 via a communication interface 818. The communication interface 818 may be a part of the processor 802 or may be a separate component. The communication interface 818 may be created in software or may be a physical connection in hardware. The communication interface 818 may be configured to connect with a network 230, external media, the display 814, or any other components in system 800, or combinations thereof. The connection with the network 230 may be a physical connection, such as a wired Ethernet connection or may be established wirelessly as discussed below. Likewise, the additional connections with other components of the system 800 may be physical connections or may be established wirelessly.

The network 230 may include wired networks, wireless networks, or combinations thereof. The wireless network may be a cellular telephone network, an 802.11, 802.16, 802.20, or WiMax network. Further, the network 230 may be a public network, such as the Internet, a private network, such as an intranet, or combinations thereof, and may utilize a variety of networking protocols now available or later developed including, but not limited to TCP/IP based networking protocols.

The computer-readable medium 822 may be a single medium, or the computer-readable medium 822 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 822 may include a solid-state memory such as a memory card or other package that houses one or more non-volatile read-only memories. The computer-readable medium 822 also may be a random access memory or other volatile re-writable memory. Additionally, the computer-readable medium 822 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A computer implemented method providing solutions to problems using a problem solving framework, comprising:
receiving a request to solve a problem from a user;
identifying a template for solving the problem, the template comprising of a plurality of tasks, each task including an attribute indicating whether the task should be performed by a machine;
assigning each task to a component to perform the task, the component comprising of a machine component if the attribute of the task indicates that the task should be performed by the machine;
providing each task to each component assigned to perform each task;
receiving a response from each component assigned to perform each task;
generating a solution to the problem based on each response received from each component; and
providing the solution to the user.

2. The computer implemented method of claim 1 wherein each task is provided to each component through at least one of a mobile message, a web page, an email or a telephone call.

3. The computer implemented method of claim 1 wherein the solution to the problem is provided to the user through at least one of a mobile message, a web page, an email or a telephone call.

4. The computer implemented method of claim 1 wherein each component is associated with an attribute comprising at least one of an availability attribute, a capability attribute, a bandwidth attribute, and a social attribute.

5. The computer implemented method of claim 4 wherein the component assigned to each task is based on the attribute associated with each component.

6. The computer implemented method of claim 1 further comprising:
determining whether the response from each component is received within a period of time; and
providing each task to a second component if the response is not received within the period of time.

7. The computer implemented method of claim 1 wherein the user is charged a fee for the solution.

8. The computer implemented method of claim 1 wherein each component is provided with a payment for each response.

9. The computer implemented method of claim 1 further comprising providing an advertisement to the user.

10. The computer implemented method of claim 9 wherein the advertisement is related to the solution.

11. A computer implemented method of assembling and providing a problem solving framework, comprising:
(a) registering a plurality of components, at least one component comprising a machine component;
(b) generating a solution template for a problem, the solution template comprising of a plurality of ordered tasks;
(c) receiving a request to solve the problem and an associated input from a user;
(d) associating each task in the plurality of tasks with a component in the plurality of components capable of completing the task;
(e) providing an input and the task to the component associated with the task, wherein the input comprises of the user input;
(f) receiving a response from the component associated with the task;
(g) repeating steps (e) and (f) for each additional task in the plurality of tasks wherein the input for each additional task comprises of the response received from a previous task; and
(h) providing a solution to the user, the solution based on the response received from a last task in the plurality of ordered tasks.

12. The computer implemented method of claim 11 wherein the task and the input is provided to the component through at least one of a mobile message, a web page, an email or a telephone call.

13. The computer implemented method of claim 11 wherein the solution is provided to the user through at least one of a mobile message, a web page, an email or a telephone call.

14. The computer implemented method of claim 11 wherein each component is associated with an attribute comprising at least one of an availability attribute, a capability attribute, a bandwidth attribute, and a social attribute.

15. The computer implemented method of claim 14 wherein each task is associated with a task capability attribute, the task capability attribute describing a capability required for completing the task.

16. The computer implemented method of claim 15 wherein the component assigned to each task is based on the attribute associated with each component and the task capability attribute associated with each task.

17. The computer implemented method of claim 11 wherein each task is associated with a component indicator, the component indicator indicating whether each task should be assigned to the machine component.

18. The computer implemented method of claim 17 wherein each task is assigned to the machine component if the component indicator indicates that the task should be assigned to the machine component.

19. The computer implemented method of claim 11 further comprising providing an advertisement to the user.

20. The computer implemented method of claim 19 wherein the advertisement is related to the solution.

21. A system of providing solutions to problems using a problem solving framework, comprising:
a memory to store a template for solving a problem, the template comprising of a plurality of tasks, each task being associated with an attribute indicating whether the task should be performed by a machine;
an interface operatively connected to the memory, the interface to communicate with a user and a plurality of components; and
a processor operatively connected to the memory and the interface, the processor for running instructions, wherein the processor receives a request to solve the problem from the user via the interface, identifies the template for solving the problem, assigns each task to a component in the plurality of components to perform the task, the component comprising of a machine component if the attribute of the task indicates that the task should be performed by a machine, provides each task to each component assigned to perform each task via the interface, receives a response from each component assigned to perform each task via the interface, determines a solution to the problem based on the response received from each component, and provides the solution to the user via the interface.

22. The system of claim 21 wherein the interface communicates to a component in the plurality of components through at least one of a network address, a mobile message, a web page, an email or a telephone call.

23. The system of claim 21 wherein the interface communicates with the user through at least one of a mobile message, a web page, an email or a telephone call.

24. The system of claim 21 wherein the processor provides an advertisement to the user via the interface.

25. The system of claim 24 wherein the advertisement is related to the solution.
